(19) United States
(12) Patent Application Publication
(10) Pub. No.: US 2026/0229828 A1
(43) Pub. Date: Aug. 6, 2026

(54) CONNECTION STRUCTURE, BUS BAR, AND TERMINAL BLOCK

(71) Applicant: Japan Aviation Electronics Industry, Limited, Tokyo (JP)

(72) Inventors: Takuo SASAKI, Tokyo (JP); Masafumi KODERA, Tokyo (JP); Ryousuke OTSUTO, Tokyo (JP)

(21) Appl. No.: 19/444,585

(22) Filed: Jan. 9, 2026

(30) Foreign Application Priority Data
Feb. 5, 2025 (JP) 2025-017344
Feb. 5, 2025 (JP) 2025-017415
Oct. 29, 2025 (JP) 2025-182243

(51) Int. Cl. H01R 25/16; H01R 4/02; H01R 4/06; H01R 4/36; H01R 4/62; H01R 13/03; H01R 43/02

(52) U.S. Cl. CPC H01R 25/162; H01R 4/029; H01R 4/06; H01R 4/36; H01R 4/625; H01R 13/03; H01R 43/0207; H01R 43/0214; H01R 43/0221

(57) ABSTRACT

A bus bar includes a first base member made of aluminum and a metal piece of plate shape that is bonded to the first base member, a first contact portion being formed on a partial region of a front surface of the metal piece, a bonding portion being disposed on a back surface of the metal piece in a region corresponding to a region other than the partial region of the front surface of the metal piece, the back surface of the metal piece being bonded to the first base member in the bonding portion, the bus bar and the connection object being electrically connected to each other when the first contact portion makes contact with a second contact portion of the connection object.

### BACKGROUND OF THE INVENTION

The present invention relates to a connection structure, particularly to a connection structure in which a bus bar using aluminum as its base material is fitted to and thereby connected to a connection object.

The present invention also relates to a bus bar used in the connection structure, and a terminal block having the bus bar.

For example, electrical connection between a motor device and an inverter device that are used in electric vehicles is made by interconnecting a motor-side bus bar and an inverter-side bus bar. As such a bus bar, a bus bar made of copper having a low contact resistance is often used to suppress the amount of heat generated when current is applied between a motor device and an inverter device.

However, since a bus bar made of copper is to be a heavy-weight product and also relatively expensive, it is desired to use aluminum that is light-weight, excellent in electric conductivity, and relatively inexpensive.

Aside from that, while a motor-side bus bar and an inverter-side bus bar are fastened together by bolting in many cases, the need is increasing for a structure in which a motor device and an inverter device are both equipped with connectors individually, so that the motor device and the inverter device can be easily connected by fitting their connectors together.

In a connector configured such that its contact member makes contact with an elastic contact piece of a counter connector in fitting of the connector, the surfaces of the contact member and the elastic contact piece are generally plated in order to improve the heat resistance (resistance stability).

For instance, JP 2016-81734 A discloses a connector assembly in which, in fitting between a male connector 1 and a female connector 2, a terminal body 4 of round pin shape of a male terminal fitting 3 of the male connector 1 makes contact with an elastic contact piece 6 of a female terminal fitting 5 of the female connector 2 as shown in FIG. 17, and the outer peripheral surface of the terminal body 4 and the inner surface of the elastic contact piece 6 are both plated with, for instance, a silver alloy.

Also in connection between a motor-side bus bar and an inverter-side bus bar through fitting of connectors, similarly, it is desired to form metal thin films such as plating layers on the surfaces of the bus bars.

However, those bus bars may have a long and large size according to the arrangement of a motor device and an inverter device within an electric vehicle for example, and plating such bus bars would be difficult in some cases.

### SUMMARY OF THE INVENTION

The present invention has been made to solve such conventional problems and is aimed at providing a connection structure that connects a bus bar using aluminum as its base material to a connection object by fitting, while improving the heat resistance.

The present invention is also aimed at providing a bus bar used in the connection structure, and a terminal block having the bus bar.

Because it is difficult to directly plate a bus bar, the present inventors considered forming a plating layer on the front surface of a metal piece of plate shape and then bonding the back surface of the metal piece to the bus bar, thus using the plated front surface of the metal piece as a contact portion of the bus bar.

As to the bonding of the metal piece, the inventors conceived of the idea of, for instance, ultrasonic-welding the metal piece to the bus bar in order to lower the contact resistance between the bus bar and the metal piece in the case where a base member of the bus bar is made of aluminum. Owing to ultrasonic welding, metal atoms constituting the metal piece and aluminum atoms constituting the base member of the bus bar can be joined together by metallic bonding, and this can lower the contact resistance between the bus bar and the metal piece without influence from an oxide coating formed on the surface of the bus bar.

Accordingly, an experiment of ultrasonic-welding, for instance, a copper piece to a bus bar made of aluminum was carried out by using a horn for ultrasonic welding that has a welding action surface provided with a plurality of protrusion portions P in a quadrangular pyramid shape as shown in FIG. 1. As a result, while the copper piece was joined to the bus bar, the shape of the protrusion portions P of the horn for ultrasonic welding was transferred to the copper piece, so that an uneven shape portion D was formed at the front surface of the copper piece as shown in FIG. 2.

FIG. 3 shows a photograph of the front surface of the copper piece after the ultrasonic welding was actually performed.

Since the uneven shape portion D is formed at the front surface of the copper piece in this manner, even when a plating layer such as silver plating is formed on the front surface of the copper piece in advance, the plating layer would be broken by the protrusion portions P of the horn for ultrasonic welding such that the uneven shape portion D is formed to reach the copper piece, and copper would be exposed in the uneven shape portions P. When copper is exposed through the plating layer, the heat resistance (resistance stability) remarkably decreases, thus making it difficult to use the plated front surface of the copper piece as a contact portion.

The present inventors made the experiment as above and further made an intensive study. Consequently, the present inventors conceived of the idea of forming a contact portion on a partial region of a front surface of a metal piece of plate shape, disposing a bonding portion on a back surface of the metal piece in a region corresponding to a region other than the partial region of the front surface of the metal piece, and then bonding the metal piece to a base member of a bus bar. In other words, the present inventors considered that bonding between the metal piece and the base member of the bus bar is made in the bonding portion disposed on the back surface of the metal piece in a region corresponding to the other region than the contact portion, thereby preventing the contact portion from being involved in the bonding. The present inventors have completed the first invention described below by embodying the above idea.

The present inventors also considered bonding a metal piece of plate shape to a base member of a bus bar, further, fastening a contact formation plate made of metal to the base member and the metal piece by use of a fastening member such that the contact formation plate contacts the metal piece, and forming a contact portion on a surface of an overhang portion of the contact formation plate overhanging beyond the base member and the metal piece. The present inventors have completed the second invention described below by embodying the above idea.

The first invention provides a connection structure in which a bus bar is fitted to and thereby connected to a connection object,
wherein the bus bar includes a first base member made of aluminum, and a metal piece of plate shape that is bonded to the first base member,
a first contact portion is formed on a partial region of a front surface of the metal piece,
a bonding portion is disposed on a back surface of the metal piece in a region corresponding to a region other than the partial region of the front surface of the metal piece,
the back surface of the metal piece is bonded to the first base member in the bonding portion, and
the bus bar and the connection object are electrically connected to each other when the first contact portion makes contact with a second contact portion of the connection object.

The first invention provides a bus bar that is fitted to and thereby connected to a connection object, the bus bar comprising:
a first base member made of aluminum; and
a metal piece of plate shape that is bonded to the first base member,
wherein a first contact portion is formed on a partial region of a front surface of the metal piece,
a bonding portion is disposed on a back surface of the metal piece in a region corresponding to a region other than the partial region of the front surface of the metal piece,
the back surface of the metal piece is bonded to the first base member in the bonding portion, and
the bus bar is electrically connected to the connection object when the first contact portion makes contact with a second contact portion of the connection object.

The first invention provides a terminal block comprising the bus bar of the first invention described above.

The second invention provides a connection structure in which a bus bar is fitted to and thereby connected to a connection object,
wherein the bus bar includes:
   a first base member made of aluminum;
   a metal piece of plate shape that is bonded to the first base member;
   a contact formation plate made of metal that contacts the metal piece and overhangs beyond the first base member and the metal piece; and
   a fastening member that fastens the contact formation plate to the first base member and the metal piece,
wherein a first contact portion is formed on a surface of an overhang portion of the contact formation plate overhanging beyond the first base member and the metal piece, and
the bus bar and the connection object are electrically connected to each other when the first contact portion makes contact with a second contact portion of the connection object.

The second invention provides a bus bar that is fitted to and thereby connected to a connection object, the bus bar comprising:
a first base member made of aluminum;
a metal piece of plate shape that is bonded to the first base member;
a contact formation plate made of metal that contacts the metal piece and overhangs beyond the first base member and the metal piece; and
a fastening member that fastens the contact formation plate to the first base member and the metal piece,
wherein a first contact portion is formed on a surface of an overhang portion of the contact formation plate overhanging beyond the first base member and the metal piece, and
the bus bar is electrically connected to the connection object when the first contact portion makes contact with a second contact portion of the connection object.

The second invention provides a terminal block comprising the bus bar of the second invention described above.

### BRIEF DESCRIPTION OF THE DRAWINGS

FIG. 1 is a perspective view showing protrusion portions formed on a welding action surface of a horn for ultrasonic welding.

FIG. 2 is a partial perspective view showing the front surface of an ultrasonic-welded copper piece.

FIG. 3 is a photograph showing part of the front surface of the ultrasonic-welded copper piece.

FIG. 4 is a perspective view showing a connection structure according to Embodiment 1 of the invention.

FIG. 5 is a cross-sectional view showing the connection structure according to Embodiment 1.

FIG. 6 is perspective view showing a first base member being disposed on an anvil for ultrasonic welding and in a fixing jig in production of a first bus bar in Embodiment 1.

FIG. 7 is a perspective view showing a copper piece being disposed on a surface of the first base member in production of the first bus bar in Embodiment 1.

FIG. 8 is a perspective view showing a horn for ultrasonic welding being disposed on a silver plating layer of the copper piece in production of the first bus bar in Embodiment 1.

FIG. 9 is a perspective view showing a welding action surface of the horn for ultrasonic welding used in Embodiment 1.

FIG. 10 is a perspective view showing the state where the copper piece is ultrasonic-welded to the surface of the first base member in production of the first bus bar in Embodiment 1.

FIG. 11 is a perspective view showing the ultrasonic-welded copper piece as well as a surface of the silver plating layer in Embodiment 1.

FIG. 12 is a perspective view showing the state of the connection structure according to Embodiment 1 before connection.

FIG. 13 is a perspective view showing the state where six second bus bars, which are connection objects, are positioned with respect to a terminal block having six first bus bars of Embodiment 1.

FIG. 14 is a perspective view showing the state where the six second bus bars, which are connection objects, are separately connected to the six first bus bars of Embodiment 1 disposed in the terminal block.

FIG. 15 is a perspective view showing the ultrasonic-welded copper piece as well as a surface of the silver plating layer in Embodiment 2.

FIG. 16 is a cross-sectional view showing a connection structure according to Embodiment 3.

FIG. 17 is a cross-sectional view showing a conventional connector assembly.

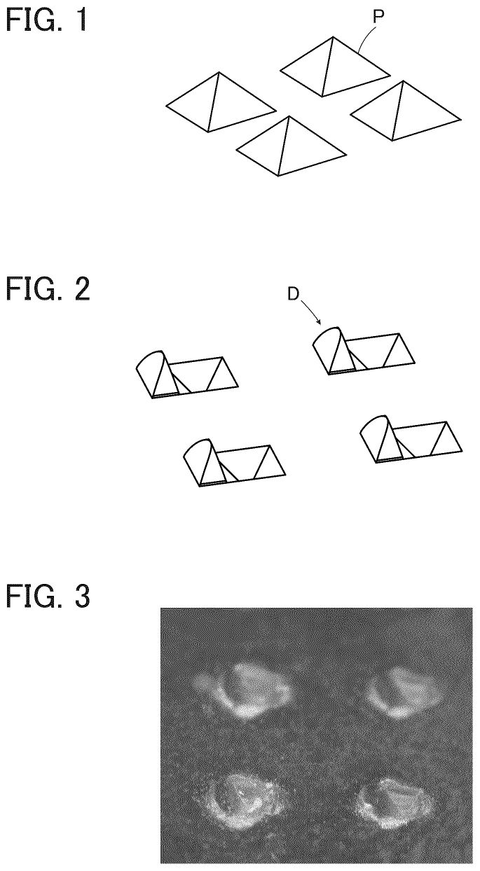

### DETAILED DESCRIPTION OF THE INVENTION

Embodiments of the invention are described below based on the accompanying drawings.

### Embodiment 1

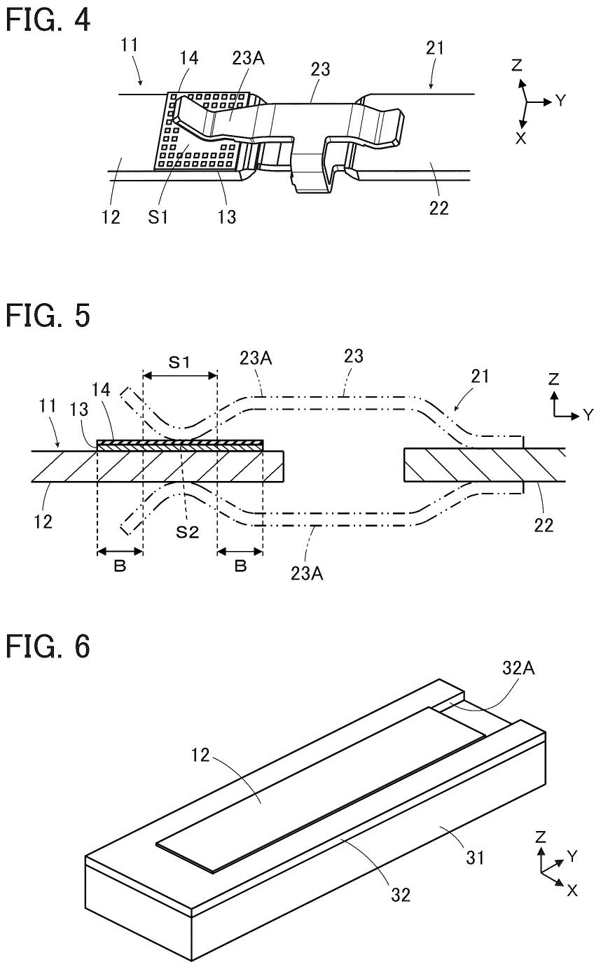

FIGS. 4 and 5 show a connection structure according to Embodiment 1 of the invention. The connection structure includes a first bus bar 11 and a second bus bar 21. The first bus bar 11 has a first base member 12 of flat plate shape that extends in a predetermined direction and is made of aluminum, and the second bus bar 21 has a second base member 22 of flat plate shape that extends in the predetermined direction same as the direction in which the first bus bar 11 extends and is made of aluminum. The first bus bar 11 constitutes a “bus bar” of the invention, and the second bus bar 21 constitutes a “connection object” of the invention.

For convenience, the direction in which the first base member 12 and the second base member 22 extend is defined as “Y direction,” the width direction of the first base member 12 and the second base member 22 as “X direction,” and the direction perpendicular to both the Y direction and the X direction as “Z direction.”

The first bus bar 11 includes a copper piece 13 of plate shape that is bonded to the surface of the first base member 12 on the +Z direction side at the +Y directional end of the first base member 12, and a silver plating layer 14 formed on the front surface of the copper piece 13 on the +Z direction side. A first contact portion S1 of rectangular shape that faces in the +Z direction is formed on a central part of the silver plating layer 14.

A bonding portion B is disposed on the back surface of the copper piece 13 on the −Z direction side in a frame-like region that corresponds to the periphery of the first contact portion S1 so as to surround the first contact portion S1. The back surface of the copper piece 13 on the −Z direction side is joined to the first base member 12 by metallic bonding in this bonding portion B. In other words, copper atoms constituting the copper piece 13 are joined to aluminum atoms constituting the first base member 12 by metallic bonding at the interface between the first base member 12 and the copper piece 13 in the bonding portion B, and no oxide coating is present between the first base member 12 and the copper piece 13.

Meanwhile, the second bus bar 21 includes an electrically conductive connection portion 23 attached to the −Y directional end of the second base member 22. The connection portion 23 is used to fit the +Y directional end of the first bus bar 11 and includes a pair of elastic contact pieces 23A that project in the −Y direction toward the first bus bar 11 and that are elastically deformable in the Z direction. The pair of elastic contact pieces 23A face each other in the Z direction, and a second contact portion S2 facing in the −Z direction is formed at the −Y directional end of, of the pair of elastic contact pieces 23A, the elastic contact piece 23A disposed on the +Z direction side.

The +Y directional ends of the pair of elastic contact pieces 23A are both electrically connected to the second base member 22.

Next, a method of producing the first bus bar 11 configured as above is described.

As shown in FIG. 6, a fixing jig 32 is disposed on an anvil 31 for ultrasonic welding. The fixing jig 32 has a cutout portion 32A to accommodate the first base member 12 of flat plate shape, and the first base member 12 is fixed on the surface of the anvil 31 for ultrasonic welding on the +Z direction side by being accommodated in the cutout portion 32A of the fixing jig 32.

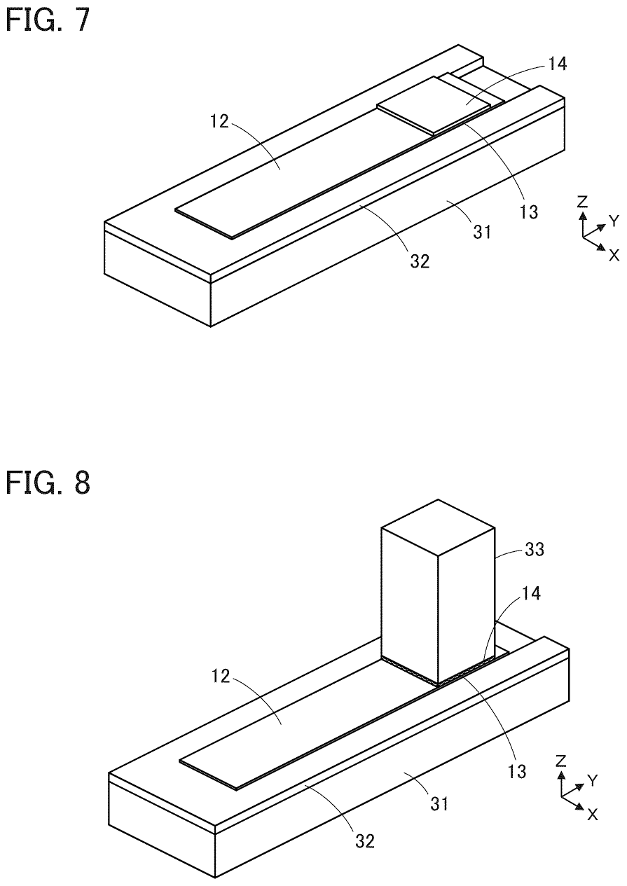

Next, as shown in FIG. 7, the copper piece 13 is disposed on the surface of the first base member 12 on the +Z direction side.

It should be noted that the silver plating layer 14 is formed on the front surface of the copper piece 13 on the +Z direction side in advance, and the back surface of the copper piece 13 on the −Z direction side makes contact with the surface of the first base member 12 on the +Z direction side. Since the copper piece 13 has a smaller size than that of the first base member 12, the front surface of the copper piece 13 can be easily plated.

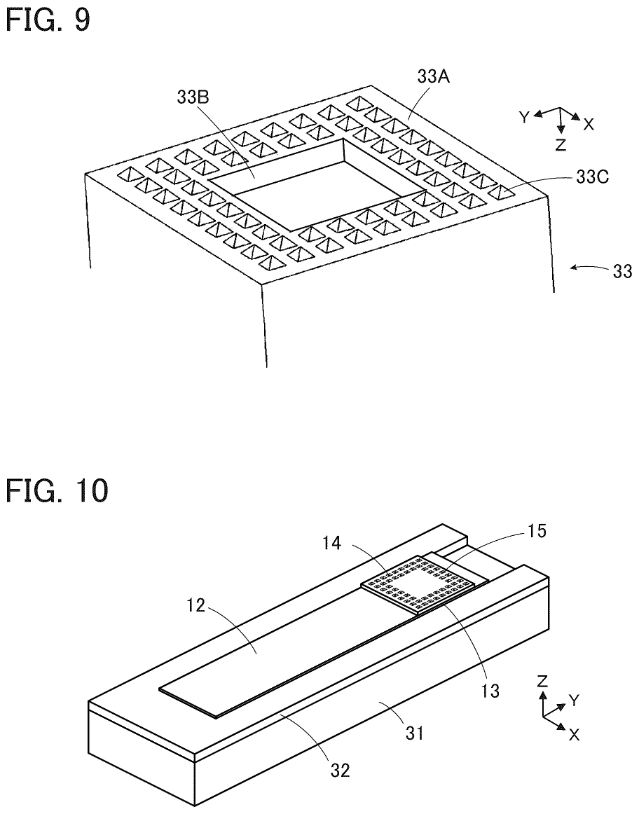

Further, a horn 33 for ultrasonic welding is disposed on the silver plating layer 14 of the copper piece 13 as shown in FIG. 8. The −Z directional end of the horn 33 for ultrasonic welding is provided with a welding action surface 33A of flat frame shape extending along an XY plane as shown in FIG. 9. The welding action surface 33A has an outer shape corresponding to the copper piece 13 and is provided in its central part with a rectangular recess portion 33B recessed toward the +Z direction. The welding action surface 33A of frame shape as above is provided with a plurality of protrusion portions 33C that are aligned in the X direction and the Y direction and have the shape of a quadrangular pyramid protruding in the −Z direction.

For instance, the protrusion portions 33C are aligned at a pitch of 0.3 to 2.5 mm or thereabout in each of the X direction and the Y direction, and each protrusion portion 33C has such a shape that four triangular lateral surfaces constituting the quadrangular pyramid rise at a 45 degree angle with respect to the welding action surface 33A, and has a height of 0.15 to 0.8 mm from the welding action surface 33A toward the −Z direction. However, the alignment pitch, the rising angle, and the height as above are only examples and can be changed as appropriate according to, for instance, the size of the copper piece 13.

The rectangular recess portion 33B formed in the center portion of the welding action surface 33A corresponds to the first contact portion S1 formed on the silver plating layer 14, and the welding action surface 33A of frame shape corresponds to the bonding portion B disposed on the back surface of the copper piece 13 on the −Z direction side.

With the welding action surface 33A as above being in contact with the silver plating layer 14, ultrasonic vibrations are applied to the horn 33 for ultrasonic welding while the horn 33 for ultrasonic welding is pressurized toward the −Z direction. The ultrasonic vibrations applied to the horn 33 for ultrasonic welding are transmitted from the welding action surface 33A of the horn 33 for ultrasonic welding to the silver plating layer 14 and the copper piece 13 and propagate inside the copper piece 13 to generate friction between the bonding portion B disposed on the back surface of the copper piece 13 on the −Z direction side and the surface of the first base member 12 on the +Z direction side. Consequently, an oxide coating formed on the surface of the first base member 12 and that formed on the back surface of the copper piece 13 that are in contact in the bonding portion B are broken, and aluminum atoms constituting the first base member 12 and copper atoms constituting the copper piece 13 are mixed together and joined to each other by metallic bonding.

At the same time, the ultrasonic vibrations applied to the horn 33 for ultrasonic welding cause friction also between the welding action surface 33A of the horn 33 for ultrasonic welding and the front surface of the copper piece 13 on the +Z direction side on which the silver plating layer 14 is formed, and as a result, an uneven shape portion 15 is formed in the silver plating layer 14 and the copper piece 13 in the region corresponding to the welding action surface 33A of frame shape due to the protrusion portions 33C of the welding action surface 33, as shown in FIG. 10. The uneven shape portion 15 is formed as a trace of the ultrasonic welding of the copper piece 13 to the first base member 12, and the protrusion portions 33C of quadrangular pyramid shape on the welding action surface 33A bite into the silver plating layer 14 and the copper piece 13, whereby the shape of the protrusion portions 33C is transferred to the silver plating layer 14 and the copper piece 13.

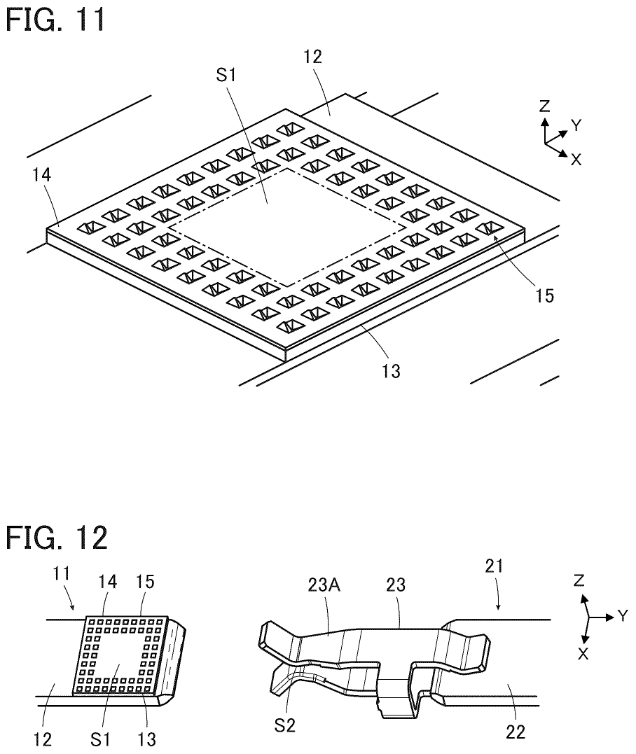

Thus, since the uneven shape portion 15 is formed in the silver plating layer 14 and the front surface of the copper piece 13 as shown in FIG. 11, it is concerned that a part of the silver plating layer 14 may be broken and copper of the copper piece 13 may be exposed in the uneven shape portion 15.

However, the uneven shape portion 15 is formed limitedly within the region corresponding to the frame-shaped welding action surface 33A of the horn 33 for ultrasonic welding where the protrusion portions 33C are present. In other words, the uneven shape portion 15 is not formed in the first contact portion S1 formed on the central part of the silver plating layer 14, so that copper is prevented from being exposed in the first contact portion S1.

Thus, the heat resistance (resistance stability) of the first contact portion S1 is maintained owing to the presence of the silver plating layer 14.

Aside from that, since the back surface of the copper piece 13 on the −Z direction side in the bonding portion B and the surface of the first base member 12 on the +Z direction side are joined together by metallic bonding, despite being made of aluminum, the first base member 12 is connected to the copper piece 13 via the bonding portion B at a low contact resistance and further electrically connected to the first contact portion S1 formed on the central part of the silver plating layer 14.

The production of the first bus bar 11 is thus completed.

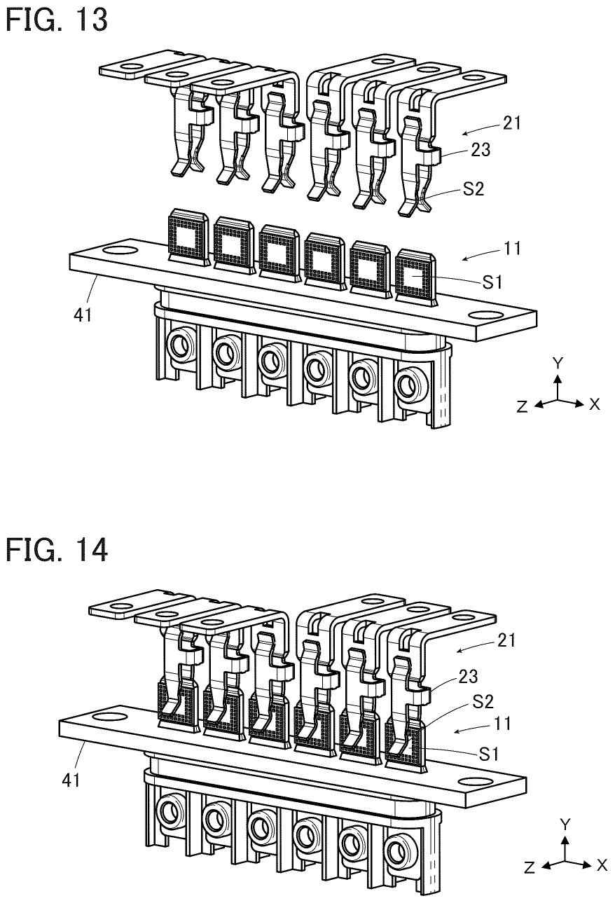

When the second bus bar 21 is connected to the first bus bar 11, as shown in FIG. 12, the second bus bar 21 is positioned on the +Y direction side of the first bus bar 11, thereafter the first bus bar 11 and the second bus bar 21 are relatively moved to approach each other, and the +Y directional end of the first bus bar 21 is inserted between the pair of elastic contact pieces 23A of the connection portion 23 of the second bus bar 21, whereby the first bus bar 11 is fitted to the connection portion 23 of the second bus bar 21.

Consequently, as shown in FIGS. 4 and 5, the first base member 12, the copper piece 13 and the silver plating layer 14 at the +Y directional end of the first bus bar 11 are held between the pair of elastic contact pieces 23A of the contact portion 23 of the second bus bar 21, and the second contact portion S2 formed on the elastic contact piece 23A disposed on the +Z direction side makes elastic contact with the first contact portion S1 formed on the central part of the silver plating layer 14.

Thus, the first base member 12 of the first bus bar 11 is electrically connected to the second base member 22 via the connection portion 23 of the second bus bar 21.

While the copper piece 13 of plate shape is bonded to the surface of the first base member 12 of the first bus bar 11 by ultrasonic welding in Embodiment 1 above, the invention is not limited thereto, and other bonding methods may be adopted as long as the copper piece 13 can be bonded to the first base member 12 at a low contact resistance through breakage of the oxide coating formed on the surface of the first base member 12 made of aluminum. For instance, the copper piece 13 may be bonded to the first base member 12 by laser welding, resistance welding, or other methods.

Aside from that, a metal piece bonded to the first base member 12 is not limited to the copper piece 13, and a metal piece of plate shape made of another metal is usable as long as it can be bonded to the first base member 12 at a low contact resistance.

Further, while the silver plating layer 14 is formed on the front surface of the copper piece 13, a plating layer made of another metal may be formed in place of the silver plating layer 14. Instead of plating the front surface of the copper piece 13, for example, a silver thin film may be adhered onto the front surface of the copper piece 13. Alternatively, a partial region of the front surface of the copper piece 13 may be directly used as the first contact portion S1 without formation of a plating layer or the like on the front surface of the copper piece 13.

FIG. 13 shows a terminal block having the first bus bars 11. The terminal block is configured to have a housing 41 made of an insulating material that retains, for example, six first bus bars 11. Six second bus bars 21 are separately disposed on the +Y direction side of the six first bus bars 11.

When the six second bus bars 21 are relatively moved in the −Y direction toward the six first bus bars 11 in the terminal block, the +Y directional ends of the first bus bars 11 are separately fitted to the connection portions 23 of the corresponding second bus bars 21 as shown in FIG. 14, and the second contact portions S2 of the second bus bars 21 make elastic contact with the first contact portions S1 of the first bus bars 11.

Thus, it is possible to electrically connect the six first bus bars 11 and the six second bus bars 21 only by fitting operation.

It should be noted that the number of the first bus bars 11 is not limited to six.

### Embodiment 2

In Embodiment 1 above, the back surface of the copper piece 13 on the −Z direction side is bonded to the first base member 12 in the bonding portion B disposed in the frame-like region that corresponds to the periphery of the first contact portion S1 so as to surround the first contact portion S1. Thus, the uneven shape portion 15 is formed over the frame-like region in the silver plating layer 14 and the front surface of the copper piece 13 as shown in FIG. 11.

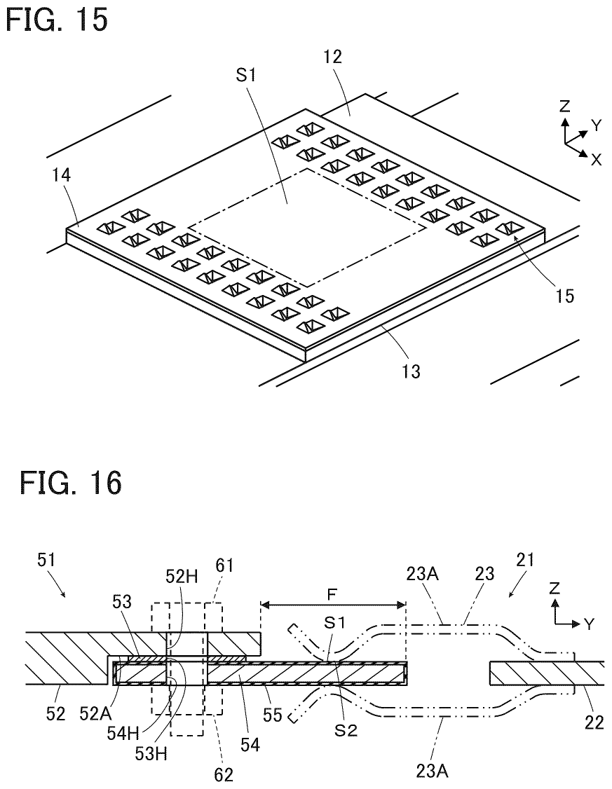

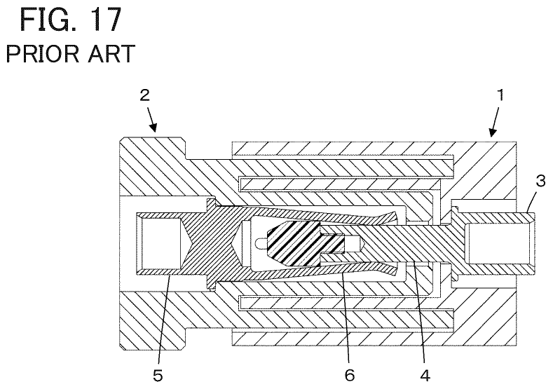

However, the invention is not limited thereto, and it suffices if the back surface of the copper piece 13 on the −Z direction side is bonded to the first base member 12 in a bonding portion disposed in a region that corresponds to the periphery of the first contact portion S1. For instance, the bonding portion may be disposed on the back surface of the copper piece 13 on the −Z direction side in regions on the opposite sides of the first contact portion S1 so as to sandwich the first contact portion S1. In this case, as shown in FIG. 15, the uneven shape portions 15 are formed in the silver plating layer 14 and the front surface of the copper piece 13 separately on the opposite sides of the first contact portion S1 in the Y direction or the opposite sides thereof in the X direction.

Even with this configuration, it is possible to electrically connect the first bus bar 11 and the second bus bar 21 as with Embodiment 1.

While the first contact portion S1 is formed on the central part of the silver plating layer 14 in Embodiments 1 and 2 above, the invention is not limited thereto, and it suffices if the first contact portion S1 is formed on a partial region of the silver plating layer 14 and the bonding portion B is disposed on the back surface of the copper piece 13 in a region corresponding to a region other than the partial region of the silver plating layer 14. For example, the first contact portion S1 may be formed on a peripheral portion excluding the central part of the silver plating layer 14, and the bonding portion B may be disposed on the central part of the back surface of the copper piece 13.

### Embodiment 3

FIG. 16 shows a connection structure according to Embodiment 3. In the connection structure, a first bus bar 51 is used instead of the first bus bar 11 in the connection structure of Embodiment 1 shown in FIGS. 4 and 5.

The first bus bar 51 includes a first base member 52 of flat plate shape that extends in the Y direction and that is made of aluminum. The +Y directional end of the first base member 52 is provided with a step portion 52A formed by cutting a −Z directional portion of the first base member 52, and a metal piece 53 of plate shape is bonded to the surface of the step portion 52A facing in the −Z direction. Further, a contact formation plate 54 made of metal and extending in the Y direction contacts the metal piece 53, and the contact formation plate 54 is fastened to the first base member 52 and the metal piece 53 by a bolt 61 and a nut 62. The first bus bar 51 is composed of the first base member 52, the metal piece 53, the contact formation plate 54, the bolt 61, and the nut 62.

A copper piece is used as the metal piece 53, and a copper plate whose surface is provided with a silver plating layer 55 is used as the contact formation plate 54.

The bolt 61 and the nut 62 constitute a fastening member used to fasten the contact formation plate 54 to the first base member 52 and the metal piece 53.

The metal piece 53 can be ultrasonic-welded to the first base member 52 using an anvil for ultrasonic welding and a horn for ultrasonic welding, as with Embodiment 1. Specifically, the first base member 52 is disposed on a surface of an anvil for ultrasonic welding such that the surface of the first base member 52 on the +Z direction side faces the anvil for ultrasonic welding, the metal piece 53 is disposed on the surface, on the −Z direction side, of the step portion 52A of the first base member 52, and further, a horn for ultrasonic welding is disposed on the metal piece 53. The horn for ultrasonic welding has a plurality of protrusion portions of quadrangular pyramid shape over the entire surface of the welding action surface facing the metal piece 53. Ultrasonic vibrations are applied to the horn for ultrasonic welding in this state, whereby the metal piece 53 is ultrasonic-welded to the first base member 52.

At this time, an uneven shape portion having a plurality of recesses in a quadrangular pyramid shape is formed at the surface of the metal piece 53 on the −Z direction side as a trace of the ultrasonic welding of the metal piece 53 to the first base member 52.

Since the metal piece 53 is ultrasonic-welded to the first base member 52, the surface of the metal piece 53 on the +Z direction side is joined to the step portion 52A of the first base member 52 by metallic bonding. In other words, copper atoms constituting the metal piece 53 are joined to aluminum atoms constituting the first base member 52 by metallic bonding at the interface between the first base member 52 and the metal piece 53, and no oxide coating is present between the first base member 52 and the metal piece 53.

Therefore, even when the first base member 52 is made of aluminum, the contact resistance between the first base member 52 and the metal piece 53 constituted of a copper piece can be lowered.

The first base member 52, the metal piece 53, and the contact formation plate 54 are provided with a through hole 52H, a through hole 53H, and a through hole 54H, respectively. When the bolt 61 is passed through the through holes 52H, 53H, and 54H and fastened with the nut 62, the first base member 52 and the metal piece 53 are fastened together with the contact formation plate 54 being pressed against the first base member 52 and the metal piece 53.

The contact formation plate 54 extends longer in the Y direction than the step portion 52A of the first base member 52 and has an overhang portion F that overhangs in the +Y direction beyond the first base member 52 and the metal piece 53. The silver plating layer 55 is formed on the surface of the contact formation plate 54, and a first contact portion S1 of the first bus bar 51 is formed on the silver plating layer 55 in the overhang portion F.

Since the contact formation plate 54 is fastened to the first base member 52 and the metal piece 53 by use of the bolt 61 and the nut 62, the contact resistance between the metal piece 53 constituted of a copper piece and the contact formation plate 54 constituted of a copper plate is low.

The first bus bar 51 as above is relatively moved toward the second bus bar 21, and the overhang portion F of the contact formation plate 54 positioned at the +Y directional end of the first bus bar 51 is inserted between the pair of elastic contact pieces 23A of the connection portion 23 of the second bus bar 21, whereby the first bus bar 51 is fitted to the connection portion 23 of the second bus bar 21.

Consequently, the overhang portion F of the contact formation plate 54 provided, on its surface, with the silver plating layer 55 is held between the pair of elastic contact pieces 23A of the contact portion 23 of the second bus bar 21, and the second contact portion S2 formed on the elastic contact piece 23A makes elastic contact with the first contact portion S1 formed on the silver plating layer 55.

Thus, the first base member 52 of the first bus bar 51 is electrically connected to the second base member 22 via the connection portion 23 of the second bus bar 21.

Since the silver plating layer 55 is formed on the surface of the contact formation plate 54 of the first bus bar 51, the heat resistance (resistance stability) of the first contact portion S1 is maintained.

In addition, since the contact formation plate 54 is fastened to the first base member 52 and the metal piece 53 by use of the bolt 61 and the nut 62 in the first bus bar 51, the contact resistance between the first base member 52 and the metal piece 53 and the contact resistance between the metal piece 53 and the contact formation plate 54 can be further reduced by increasing a fastening torque.

While the metal piece 53 of plate shape is bonded to the first base member 52 of the first bus bar 51 by ultrasonic welding in Embodiment 3 above, the invention is not limited thereto, and other bonding methods may be adopted as long as the metal piece 53 can be bonded to the first base member 52 at a low contact resistance through breakage of the oxide coating formed on the surface of the first base member 52 made of aluminum. For instance, the metal piece 53 may be bonded to the first base member 52 by laser welding, resistance welding, or other methods.

Aside from that, the metal piece 53 bonded to the first base member 52 is not limited to the copper piece, and a metal piece of plate shape made of another metal is usable as long as it can be bonded to the first base member 52 at a low contact resistance.

In addition, the contact formation plate 54 fastened to the first base member 52 and the metal piece 53 by use of the bolt 61 and the nut 62 is not limited to the copper plate, and a plate member made of another metal is usable as long as it can contact the metal piece 53 at a low contact resistance.

Fastening of the contact formation plate 54 to the first base member 52 and the metal piece 53 is not limited to the method using the bolt 61 and the nut 62, and the contact formation plate 54 may be fastened to the first base member 52 and the metal piece 53 by, for instance, screw joining or rivet joining.

While the silver plating layer 55 is formed on the surface of the contact formation plate 54, a plating layer made of another metal may be formed in place of the silver plating layer 55. Instead of plating the surface of the contact formation plate 54, for instance, a silver thin film may be adhered onto the surface of the contact formation plate 54. While the formation of a plating layer or the like on the surface of the contact formation plate 54 is not essential, it is favorable to form a plating layer or the like on the surface of the contact formation plate 54 in order to maintain the heat resistance (resistance stability) of the first contact portion S1.

A terminal block having a plurality of the first bus bars 51 according to Embodiment 3 can be configured in the same manner as the terminal block shown in FIGS. 13 and 14.

The invention is not limited to the connection between the first bus bar 11 and the second bus bar 21 and is also applicable to a connection structure in which, in place of the second bus bar 21, a connection object such as a terminal is used, and the first bus bar 11 is fitted and thereby electrically connected to the connection object.

What is claimed is:

1. A connection structure in which a bus bar is fitted to and thereby connected to a connection object,
wherein the bus bar includes a first base member made of aluminum, and a metal piece of plate shape that is bonded to the first base member,
a first contact portion is formed on a partial region of a front surface of the metal piece,
a bonding portion is disposed on a back surface of the metal piece in a region corresponding to a region other than the partial region of the front surface of the metal piece,
the back surface of the metal piece is bonded to the first base member in the bonding portion, and
the bus bar and the connection object are electrically connected to each other when the first contact portion makes contact with a second contact portion of the connection object.

2. The connection structure according to claim 1,
wherein the partial region on which the first contact portion is formed is a central part of the front surface of the metal piece, and
the bonding portion is disposed so as to surround a periphery of the first contact portion.

3. The connection structure according to claim 1,
wherein the partial region in which the first contact portion is formed is a central part of the front surface of the metal piece, and
the bonding portion is disposed on opposite sides of the first contact portion so as to sandwich the first contact portion.

4. The connection structure according to claim 1,
wherein the metal piece is constituted of a copper piece bonded to the first base member by one of ultrasonic welding, laser welding, and resistance welding.

5. The connection structure according to claim 1,
wherein the bus bar includes a silver plating layer formed on the front surface of the metal piece, and
the first contact portion is formed on the silver plating layer.

6. A bus bar that is fitted to and thereby connected to a connection object, the bus bar comprising:
a first base member made of aluminum; and
a metal piece of plate shape that is bonded to the first base member,
wherein a first contact portion is formed on a partial region of a front surface of the metal piece,
a bonding portion is disposed on a back surface of the metal piece in a region corresponding to a region other than the partial region of the front surface of the metal piece,
the back surface of the metal piece is bonded to the first base member in the bonding portion, and
the bus bar is electrically connected to the connection object when the first contact portion makes contact with a second contact portion of the connection object.

7. The bus bar according to claim 6,
wherein the partial region on which the first contact portion is formed is a central part of the front surface of the metal piece, and
the bonding portion is disposed so as to surround a periphery of the first contact portion.

8. The bus bar according to claim 6,
wherein the partial region on which the first contact portion is formed is a central part of the front surface of the metal piece, and
the bonding portion is disposed on opposite sides of the first contact portion so as to sandwich the first contact portion.

9. The bus bar according to claim 6,
wherein the metal piece is constituted of a copper piece bonded to the first base member by one of ultrasonic welding, laser welding, and resistance welding.

10. The bus bar according to claim 6,
wherein the bus bar includes a silver plating layer formed on the front surface of the metal piece, and
the first contact portion is formed on the silver plating layer.

11. A terminal block comprising the bus bar according to claim 6.

12. A connection structure in which a bus bar is fitted to and thereby connected to a connection object,
wherein the bus bar includes:
a first base member made of aluminum;
a metal piece of plate shape that is bonded to the first base member;
a contact formation plate made of metal that contacts the metal piece and overhangs beyond the first base member and the metal piece; and
a fastening member that fastens the contact formation plate to the first base member and the metal piece,
wherein a first contact portion is formed on a surface of an overhang portion of the contact formation plate overhanging beyond the first base member and the metal piece, and
the bus bar and the connection object are electrically connected to each other when the first contact portion makes contact with a second contact portion of the connection object.

13. The connection structure according to claim 12,
wherein the fastening member is one of a bolt, a screw, and a rivet.

14. The connection structure according to claim 12,
wherein the metal piece is constituted of a copper piece bonded to the first base member by one of ultrasonic welding, laser welding, and resistance welding.

15. The connection structure according to claim 12,
wherein the contact formation plate is constituted of a copper plate whose surface is provided with a silver plating layer, and
the first contact portion is formed on the silver plating layer.

16. A bus bar that is fitted to and thereby connected to a connection object, the bus bar comprising:
a first base member made of aluminum;
a metal piece of plate shape that is bonded to the first base member;
a contact formation plate made of metal that contacts the metal piece and overhangs beyond the first base member and the metal piece; and
a fastening member that fastens the contact formation plate to the first base member and the metal piece,
wherein a first contact portion is formed on a surface of an overhang portion of the contact formation plate overhanging beyond the first base member and the metal piece, and
the bus bar is electrically connected to the connection object when the first contact portion makes contact with a second contact portion of the connection object.

17. The bus bar according to claim 16,
wherein the fastening member is one of a bolt, a screw, and a rivet.

18. The bus bar according to claim 16,
wherein the metal piece is constituted of a copper piece bonded to the first base member by one of ultrasonic welding, laser welding, and resistance welding.

19. The bus bar according to claim 16,
wherein the contact formation plate is constituted of a copper plate whose surface is provided with a silver plating layer, and
the first contact portion is formed on the silver plating layer.

20. A terminal block comprising the bus bar according to claim 16.
